(19) United States
(12) Patent Application Publication
(10) Pub. No.: US 2009/0213093 A1
(43) Pub. Date: Aug. 27, 2009

(54) Optical position sensor using retroreflection

(75) Inventor: Simon James Bridger, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holdings Limited, Auckland City (NZ)

(21) Appl. No.: 12/319,546

(22) Filed: Jan. 7, 2009

Related U.S. Application Data
(60) Provisional application No. 61/019,406, filed on Jan. 7, 2008.

(51) Int. Cl. G06F 3/042

(52) U.S. Cl. 345/175

(57) ABSTRACT

An optical position sensing system includes a display surrounded by a bezel, which may have high performance prismatic retroreflective film applied to it. The prismatic film may have a plurality of metallized and canted cube corner, with cant angles of greater than 5 degrees. The system also includes least one position sensing component, including at least one radiation source and an optical sensor. An optical position sensing component may include a plurality of radiation source, to improve performance of more diffuse retroreflective film. The position of the radiation source(s) may be varied with respect to the aperture to achieve further performance enhancements. Supplemental radiation sources may be positioned around the bezel so as to provide supplemental backlighting. Each of the plurality of supplemental radiation sources can be individually activated and deactivated, so as to selectively provide said supplemental backlighting to selected areas within the bezel.

### RELATED APPLICATIONS

This application claims priority to U.S. Provisional Patent Application No. 61/019,406, entitled “Optical Position Sensor Using Retroreflection,” which was filed on Jan. 7, 2008.

### TECHNICAL FIELD

The present invention relates generally to position sensing systems, such as touch screens and interactive whiteboards. More particularly, the present invention relates to position sensing systems that incorporate electromagnetic radiation sources, retroreflectors and optical sensors to determine the position of a pointer or other object.

### BACKGROUND OF THE INVENTION

Certain known optical position sensing systems, such as optical touch screens or whiteboards, rely on a combination of electromagnetic radiation, retroreflectors, optical sensors, digital signal processing, and algorithms to determine the position of a pointer or other object within a viewing area. As shown in FIG. 1, a frame or bezel 105 borders the viewing area of the display 110 in an exemplary optical position sensing system 100. Position sensing components 130, 131 are positioned in at least two corners of the bezel 105. Each position sensing component 130, 131 includes an electromagnetic radiation source 120 and optical sensor 121. The electromagnetic radiation source 120, such as a light emitting diode (LED), emits electromagnetic radiation 140, such as ultraviolet, visible or infrared light, into the viewing area of the display 110. The electromagnetic radiation 140 is reflected back towards its source 120 by retroreflectors 107 applied to the frame or bezel 105. The electromagnetic radiation 140 thus “illuminates” the viewing area. A pointer or other object placed within the viewing area disturbs the illumination and creates a shadow.

Many optical touch screen systems 100 use optical position sensors 121 such as line-scanning cameras or area-scanning cameras to image the bezel 105. Such sensors 121 can detect variations in illumination levels within the viewing area and output signals that can be used to determine the position of the shadow., i.e., the “touch point”. In retroreflector-based optical position sensing systems, it is generally advantageous to position an optical sensor 121 in close proximity to a radiation source 120 because the recursively reflected electromagnetic radiation 140 will necessarily be more intense near the radiation source 120. Signals from two or more optical sensors 121 may be used by components of the computing device 150 to determine the position of the touch point using triangulation or other well-known methods.

Compared to other position sensing technologies, optical position sensing systems have a lower incremental cost, particularly as size increases, and can provide substantially higher resolution and data rates. Simple retroreflector-based optical position sensing systems in particular tend to have a relatively low manufacturing cost. This is because retroreflectors 107 are generally inexpensive and are commonly produced in the form of films, tapes or paints, all of which can be easily applied to the frame or bezel 105 of a display 110.

FIG. 2 is an illustration of a common “glass bead” retroreflective film 200, which is one example of a retroreflector 107. The glass bead film 200 has a surface formed by a layer of tiny transparent spheres 202, such as glass beads. FIG. 3 is an illustration of a common “prismatic” retroreflective film 300, which is another example of a retroreflector 107. The prismatic film includes an embedded layer of metallized triangular cube corner elements 302. In each of these forms of retroreflective film 200, 300, incident electromagnetic radiation waves or beams 204, 304 (i.e. the light beams that enters the film) are reflected back toward the radiation source generally along a line that is parallel to the incident wave or beam 204, 304.

As shown in FIG. 2 and FIG. 3, the return pattern (sometimes called “recursive signal”) of a prismatic film 300 is generally less diffuse than that of a glass bead film 200. As a result, prismatic films 300 have higher reflectivity and are therefore generally more desirable for use as retroreflectors 107 in optical position sensing systems 100. As shown in FIG. 1, in conventional retroreflective-based optical position sensing systems using prismatic film, only one radiation source 120 per optical sensor 121 is needed due to the high reflectivity of the prismatic film 300. However, the reflectivity of conventional prismatic film 300 is highly dependent upon the angle at which incident beams 304 contact the film 300. In other words, reflectivity decreases at incident angles above or below a particular range Therefore, using a prismatic film 300 in an optical position detection system 100 can result in portions of the viewing area (especially at or near the corner regions of the display 110) that have low reflectivity. Thus, the optical sensors 121 will observe a non-uniform illumination background and the system will have difficulty detecting the shadow caused by introduction of a pointer in the areas of low reflectivity. This problem has become dramatically worse as wide screen formats have diagonal angles that are beyond the usable range of prismatic retro materials.

Another disadvantage of retroreflector-based optical position sensing systems using high performance prismatic films 300 is that prismatic film 300 can be sensitive to water droplets and other refracting contaminants on the surface of the film. Glass bead film 200, due to its more diffuse return pattern is less sensitive to water droplets in some cases. However the signal is weaker. Because the spherical bead components 202 are located on the surface of the film 200 in the best performing bead type retro, water destroys the reflectivity of exposed bead material. However, as discussed above, the recursive signal of a glass bead film 200 is generally more diffuse than that of a prismatic film 300, and thus provides reflectivity that is lower than desired for most current optical position sensing systems 100.

Accordingly, what is needed are systems and methods for enhancing the performance of retroreflector-based optical position sensing systems.

### SUMMARY OF THE INVENTION

The present invention provides systems and methods for overcoming the limitations of existing retroreflector-based optical position sensing systems. An optical position sensing system includes a display surrounded by a bezel. Retroreflective material is applied to the bezel. The retroreflective material can be glass bead film. In other embodiments, the retroreflective material comprises high performance prismatic film. For example, the prismatic film may have a plurality of metallized and canted cube corner. The cant angle of the cube corners may be greater than 5 degrees.

The system also includes least one position sensing component, which may include one or more radiation sources. According to certain aspects of the invention, each optical sensor includes a plurality of radiation source and each emits radiation that contacts reflective components of the retroreflective material at different incident angles to cause illumination of the bezel. The position of the radiation source(s) may be varied with respect to the aperture to achieve further performance enhancements. The position sensing component also includes an optical sensor that generates data signals representing detected variations in illumination. Position sensing components are in communication with a processor for processing the data signals to calculate a location of a touch relative to the display.

In accordance with other aspects of the invention, the optical position sensing system may include a plurality of supplemental radiation sources positioned around the bezel so as to provide supplemental backlighting therein. Each of the plurality of supplemental radiation sources can be individually activated and deactivated, so as to selectively provide said supplemental backlighting to selected areas within the bezel.

These and other aspects and features of the invention will be described further in the detailed description below in connection with the appended drawings and claims.

### BRIEF DESCRIPTION OF THE DRAWINGS

FIG. 1 is an illustration of a retroreflector-based optical position sensing system.

FIG. 2 is cross-sectional view of a glass bead retroreflective film.

FIG. 3 is cross-sectional view of a prismatic retroreflective film.

FIG. 4 is an illustration of a retroreflector-based optical position sensing system, in accordance with certain exemplary embodiments of the present invention.

FIG. 5 is an illustration of a retroreflector-based optical position sensing system having supplemental backlighting capabilities, in accordance with certain exemplary embodiments of the present invention.

FIG. 6 is an illustration of a retroreflector-based optical position sensing system having supplemental backlighting capabilities, in accordance with certain other exemplary embodiments of the present invention.

FIG. 7 is a flow chart illustrating an exemplary method for selectively activating/deactivating supplemental backlighting in a retroreflector-based optical touch screen system, in accordance with certain embodiments of the present invention.

FIG. 8 illustrate an optical position sensor component configuration that is optimized for use with narrow return angle retroreflective material, such as high performance prismatic sheeting, in accordance with various exemplary embodiments of the present invention.

FIG. 9 is an illustration of a unidirectional canted prismatic retroreflective film, in accordance with various exemplary embodiments of the present invention.

FIG. 10 illustrates several possible arrangements of a plurality of electromagnetic radiation sources around an aperture, in accordance with various exemplary embodiments of the present invention.

FIG. 11 illustrate improved optical position sensor component configurations for glass bead retroreflective materials, or where refractive contaminants may affect the retroreflective surface, in accordance with various exemplary embodiments of the present invention.

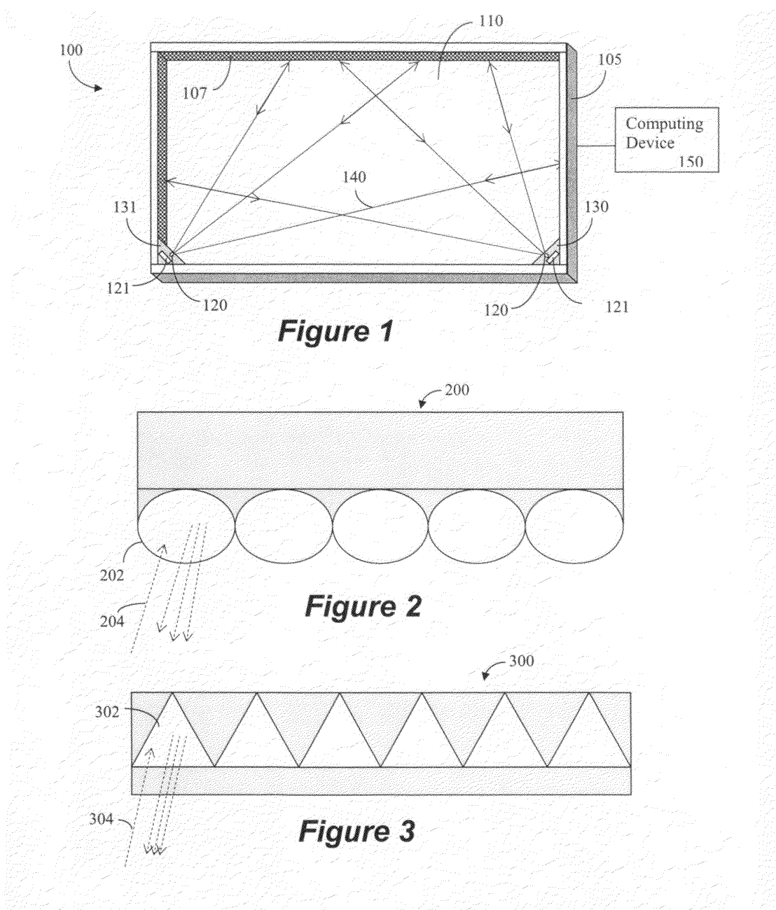

### DETAILED DESCRIPTION OF EXEMPLARY EMBODIMENTS OF THE INVENTION

The present invention provides performance enhancements for retroreflector-based optical position sensing systems. Systems and methods of the present invention provide unique designs that increase the reflectivity and effectiveness of retroreflective film used in connection with optical touch screens.

Reference will now be made in detail to various and alternative exemplary embodiments and to the accompanying drawings, with like numerals representing substantially identical structural elements. Each example is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations as come within the scope of the appended claims and their equivalents.

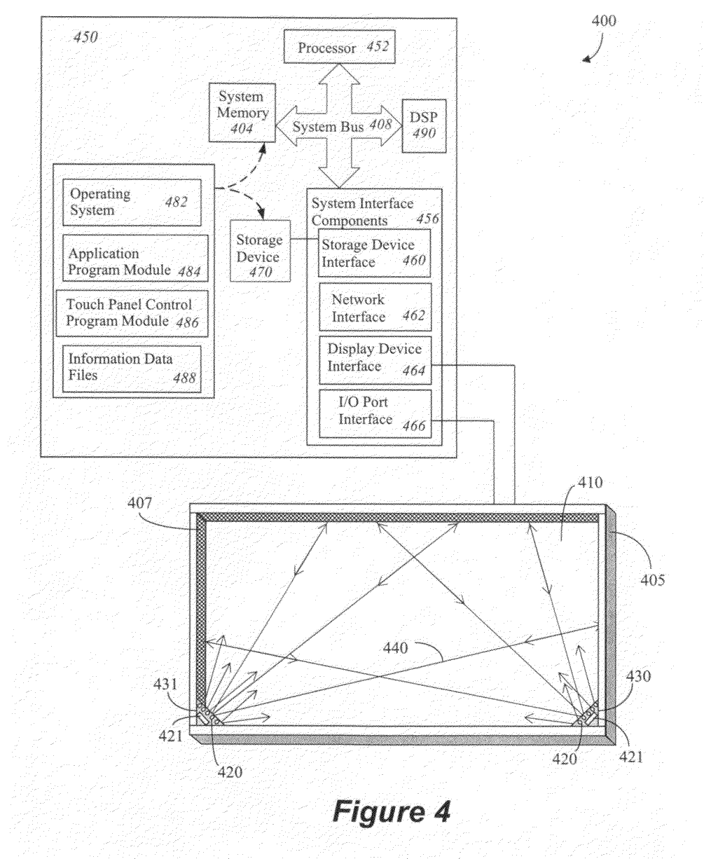

FIG. 4 is an illustration of an exemplary position sensing system, referred to hereinafter as a touch screen system 400. As used herein, the term “touch screen system” is meant to refer to a display 410 and the hardware and/or software components that provide position sensing or touch detection functionality. The exemplary touch screen system 400 includes a display 410 having one or more position sensing components 430, 431 and interfaced to a computing device 450, which executes one or more software modules for detecting a touch point (i.e., sensing the position of a pointer) on or near the display 410. The position sensing components 430, 431 have optical paths that are advantageously made long and thin. This results in an illumination plane that is slightly above and parallel to the viewing area of the display 410. Accordingly, the viewing area and illumination plane overlap only at objects distant from each position sensing component 430, 431. Objects relatively close to each position sensing component 430, 431 (e.g. the screen surface, bezel, display frame, etc.) are shadowed. This reduces the near field effect and protects the optical sensor 421 from external interference such as spotlights and sunlight. The touch screen system 400 thus enables a user to view and interact with visual output presented on the display 410.

The computing device 450 may be functionally coupled to the display 410 and/or position sensing component 430, 431 by a hardwire or wireless connection. As mentioned, the computing device 450 may be any type of processor-driven device, such as a personal computer, a laptop computer, a handheld computer, a personal digital assistant (PDA), a digital and/or cellular telephone, a pager, a video game device, etc. These and other types of processor-driven devices will be apparent to those of skill in the art. As used in this discussion, the term “processor” can refer to any type of programmable logic device, including a microprocessor or any other type of similar device.

The computing device 450 may include, for example, a processor 452, a system memory 454 and various system interface components 456. The processor 452, system memory 454 and system interface components 456 may be functionally connected via a system bus 458. The system interface components 456 may enable the processor 452 to communicate with peripheral devices. For example, a storage device interface 460 can provide an interface between the processor 452 and a storage device 470 (e.g., a removable or non-removable disk drive). A network interface 462 may also be provided as an interface between the processor 452 and a network communications device (not shown), so that the computing device 450 can be connected to a network.

A display device interface 464 can provide an interface between the processor 452 and the display 410, which may be a computer monitor, whiteboard or other display device. One or more input/output (“I/O”) port interfaces 466 may be provided as an interface between the processor 452 and various input and/or output devices. For example, the position sensing components 430, 431 may be functionally connected to the computing device 450 via suitable input/output interface(s) 466.

A number of program modules may be stored in the system memory 454 and/or any other computer-readable media associated with the storage device 470 (e.g., a hard disk drive). The program modules may include an operating system 482. The program modules may also include an application program module 484 comprising computer-executable instructions for displaying images or other items on the display 410. One or more touch screen control program module(s) 486 and/or a digital signal processing unit (DSP) 490 may be included for controlling the position sensing components 430, 431 of the touch screen system 400 and/or for calculating touch points and cursor positions relative to the display 410. Those of ordinary skill in the art will understand that such functions may also be implemented by other means, such as by the operating system 482, by another driver or program module rumbling on the computerized device 450, or by a dedicated touch screen controller device. These and other means for calculating touch points and cursor positions relative to a display 410 in a touch screen system 400 are contemplated by the present invention.

The processor 452, which may be controlled by the operating system 482, can be configured to execute the computer-executable instructions of the various program modules. The methods of the present invention may be embodied in such computer-executable instructions. Furthermore, the images or other information displayed by the application program module 484 and other program modules may be stored in one or more data files 488, which may be stored on any computer-readable medium associated with the computing device 450.

The exemplary touch screen system 400 may be used in conjunction with displays 410 of all sizes and dimensions, including but not limited to the display screens of small handheld devices, such as mobile phones, personal digital assistants (PDA), pagers, etc. Those skilled in the art will appreciate that the exemplary touch screen system does not necessarily require a user to touch the display 410 in order to interact with the system. Accordingly, use of the term “touch” herein is intended to refer generally to an interaction between a pointer and a display 410 and not specifically to contact between the pointer and the display 410.

A frame or bezel 405 surrounds the perimeter of the display 410. A retroreflective material 407 is positioned along the inner surface of the bezel 405, which is generally perpendicular to the viewing area of the display 410. The retroreflective material 407 may be attached to the bezel 405 with a clear adhesive or any other suitable bonding agent and used directly as a reflector. Alternatively, the retroreflective material 407 may be embedded within the bezel 405 or positioned behind the bezel 405 or viewed through a bezel cover.

In certain embodiments, the retroreflective material 407 is a glass bead retroreflective tape, film or paint (e.g., glass bead film 200). Although it has a more diffuse recursive signal than prismatic material, glass bead material may be chosen because it is less vulnerable to condensation or other environmental contaminants. To further lessen the impacts of condensation, the surfaces of the retroreflectoive material 407 or the bezel 405 may be coated with a hydrophilic coating to flatten liquid droplets. The retroreflective material 407 or bezel 405 may also be covered with other compositions suitable for lessening the adverse effect of condensation or other environmental contaminants.

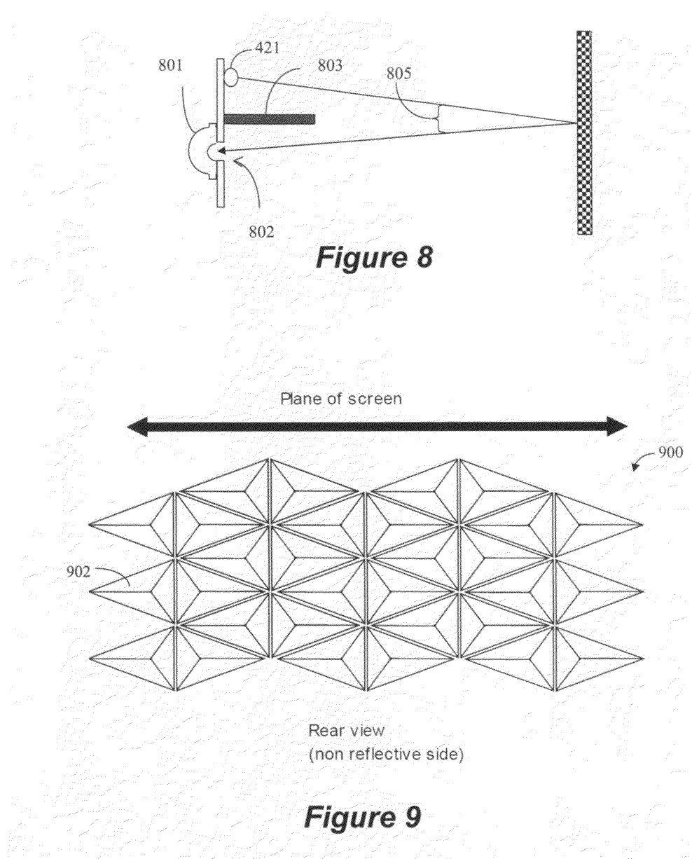

In certain embodiments, the configuration of the position sensing components 430, 431 is optimised so that the observation angle of the optical sensor 430 is very small for operation with prismatic films on small screens. Such a configuration is illustrated in FIG. 8A and FIG. 8B. Each position sensing component 430, 431 includes a lens 801, an aperture 802 and a light path separator 803. The lens 801 is positioned behind the aperture 802 and defines a field of view for the optical sensor 421 (not shown). The light path separator 803 is positioned between the radiation source 420 and the aperture 802 and optically separates the radiation path from the imaging path. The components are further arranged such that the observation angle 805 between the radiation source 420, retroreflective material 407 and aperture 802 is very small.

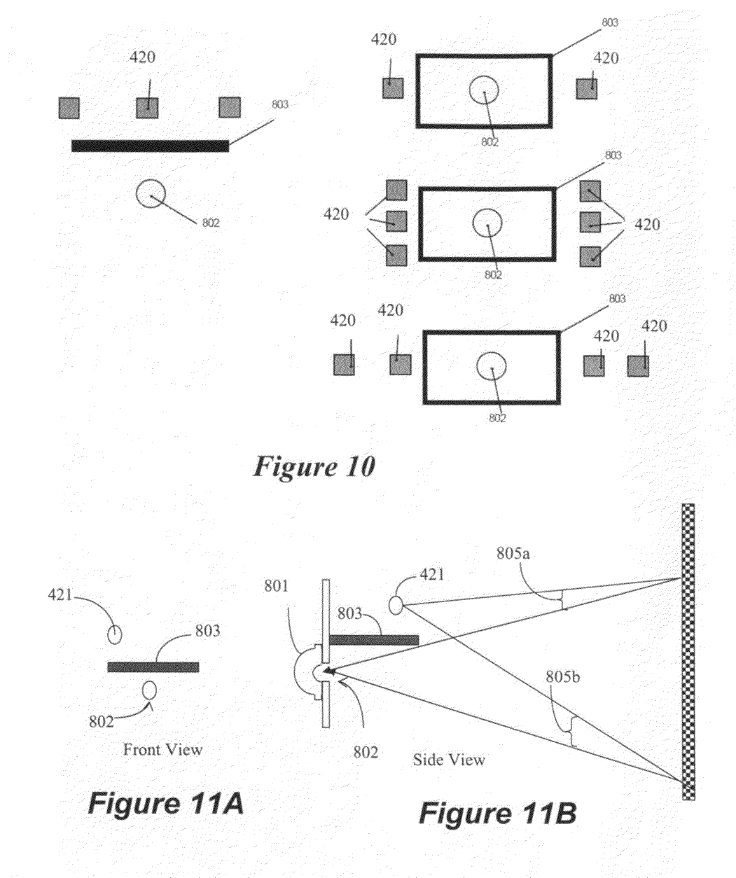

To enhance the return signal with the more diffuse recursive signal produced by glass bead retroreflective material, or where refractive contaminants are likely to be present on a prismatic film each position sensing component 430, 431 of the exemplary touch screen system 400 includes a plurality of electromagnetic radiation sources 420 around the aperture 802. FIG. 10 illustrates a range of possible arrangements, and many others are possible. In all of these, the observation angle 805 will be greater than in FIG. 8. When the pattern is more diffuse such as for glass bead retroreflective material, this will result in more source radiation falling within the return signal zone. When a high performance material, such as prismatic retroreflective film, is being impaired by refractive contaminants, it will provide diversity of sources to account for bending of the return path.

The plurality of electromagnetic radiation sources 420 each emit energy beams 440 across the viewing area of the display 410. The emitted energy beams 440 from each electromagnetic radiation source 420 contact the reflective components of retroreflective material 407 at a slightly different incident angle. The plurality of electromagnetic radiation sources 420 emit energy beams 440 that span a wider angle than those emitted by a single electromagnetic radiation source. Typically the plurality of electromagnetic radiation sources 420 emit energy beams spanning an angle that is in the range of greater than about 0.2 degrees and less than about 1 degree. The use of a plurality of electromagnetic radiation sources 420 arranged in the vicinity of the optical sensor 421 thus provides alternative paths that the reflected energy beams 440 can take from electromagnetic radiation source 420 to optical sensor 421. As a result, the performance of the optical sensor 421 is enhanced because it receives a sum of multiple overlapping recursive signals.

In certain embodiments, such as those involving small displays 410, the plurality of electromagnetic radiation sources 420 are arranged on a single axis. In other embodiments, such as those involving large displays 410, the electromagnetic radiation sources 420 may be arranged to provide an area of discrete electromagnetic radiation sources 420. In still other embodiments, a diffused electromagnetic radiation source may be used in place of the plurality of electromagnetic radiation sources 420. Each of the plurality of electromagnetic radiation sources 420 may be individually controlled, so that they be activated according to a configurable duty cycle, or activated in selectable combinations according to operating conditions. Control of the electromagnetic radiation sources 420 may be handled by the touch panel control program module 486 or other suitable component of the computing device 450.

In certain embodiments, such as the exemplary embodiment shown in FIG. 4, two optical sensors 421 are used to image the viewing area of the display 410. Where two sensors 421 are used in a touch screen system 400, interference between the two sensors 421 may occur, which can adversely affect the performance of either sensor 421. For example, the optical sensor 421 of position sensing component 430 may detect a bright reflection created by the energy beams 440 emitted from the radiation source 420 of position sensing component 431, and vice versa, which distorts the image detected and processed by each optical sensor 421. Also, the radiation source 420 of one position sensing component 430 may be directly imaged by the optical sensor 421 of the other position sensing component 431. Accordingly, in certain embodiments of the present invention, the front face (or other layers) of the bezel 405 is adjusted outwardly by a small amount (e.g. about 10 degrees) to prevent the undesirable reflective interference from radiation sources 420 of the respective position sensing devices 430, 431. In other embodiments, the periods during which each radiation source 420 is allowed to emit electromagnetic radiation 440 are phased or timed so that sensors 421 of position sensing devices 430, 431 are not imaging the viewing area at the same time. This can be implemented by configuring the optical sensors 421 to image the viewing area according to a configurable duty cycle or round robin schedule, or configuring the optical sensors 421 to alternatively activate radiation sources 420 at different times. Those skilled in the art will appreciate other ways of limiting the reflective interference caused by the use of two or more optical sensors 421 in touch screen system 400.

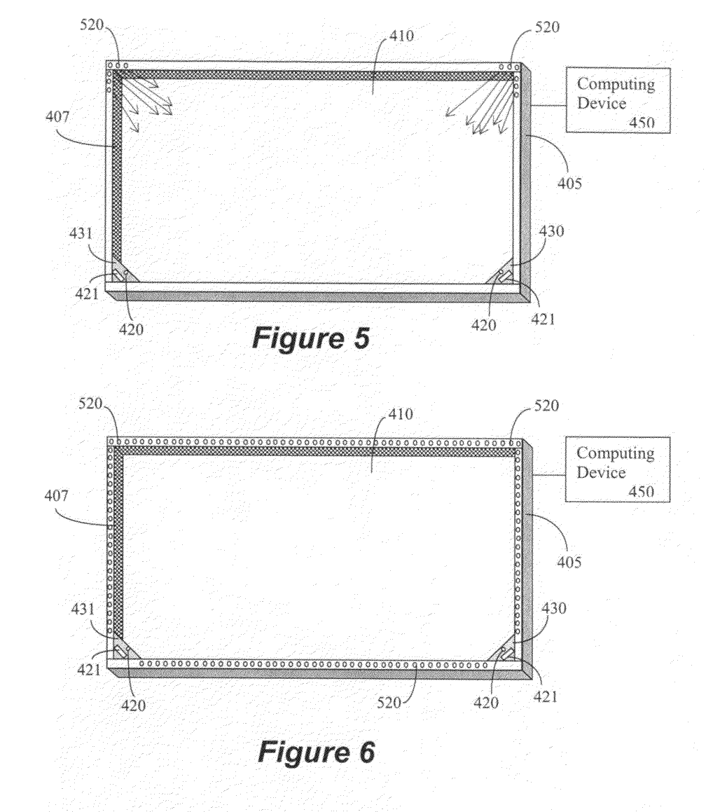

FIGS. 5 and 6 illustrate alternative embodiments of the present invention, in which selected regions of the display 410 are provided with supplemental backlighting. As mentioned, retroreflector-based touch screen systems often suffer from poor signal strength in certain parts of the display 410, such as the edges or corners thereof, due to inherent limitations of the retroreflective material. Signal degradation can also occur due to the presence of environmental contaminants, such as moisture and dust. Although systems utilizing prismatic retroreflective material are more prone to such disadvantages, systems utilizing glass bead retroreflective material can be affected as well. Accordingly, the retroreflective material 407 used in the embodiments shown and described with respect to FIGS. 5 and 6 can be of the prismatic or glass bead type, or any other suitable retroreflective material.

In order to enhance the signal strength in certain regions of the display 410, additional electromagnetic radiation sources 520 (e.g., LED) are selectively positioned around the display (e.g., within or on the bezel 405) to provide supplemental backlighting. Preferably, the backlighting sources 520 emit the same type of radiation as emitted by the primary electromagnetic radiation sources 420 (e.g., IR, UV or visible light), so that additional optical sensor 421 are not needed. In some cases it may be desirable that the backlighting sources 520 emit radiation at a different wavelength or frequency than that of the primary electromagnetic radiation sources 420. In still other embodiments, the backlighting sources 520 may emit a type of radiation that is different from that emitted by the primary electromagnetic radiation sources 420, and corresponding optical sensors can be added to the position sensing components 430, 431. In the embodiments contemplated by FIGS. 5 and 6, each position sensing component 430, 431 may include one or more electromagnetic radiation sources 420.

Although FIG. 5 shows backlighting sources 520 positioned near corner regions of the display 410, it is possible to position the backlighting sources 520 near any other selected region(s) of the display 410 or, as shown in FIG. 6, around a substantial portion of the display 410. In other configurations, the backlighting sources 520 may replace or be combined with certain sections of the retroreflective material 407. For example, the retroreflective material 407 along on edge of a display where condensation typically collects might be replaced by an array of backlighting sources 520.

The radiation emitted by the backlighting sources 520 is directed across the viewing area of the display 410 toward the general area of the position sensing components 430, 431, compensating for the otherwise weaker recursive signal strength. As a result, the signal received by each optical sensor 421 is enhanced, allowing the optical sensor 421 to more accurately detect illumination variations across the viewing area of display 410. The backlighting sources 520 may be individually controlled (e.g., by the touch panel control program module 486 or other suitable component of the computing device 450), so one or more can be selectively activated according to a configurable duty cycle or on an as needed basis. For example, selected backlighting sources 520 may be activated only when the system determines that the strength of the recursive signal produced by the retroreflective material 407 has fallen below a certain level for any particular region of the display 410.

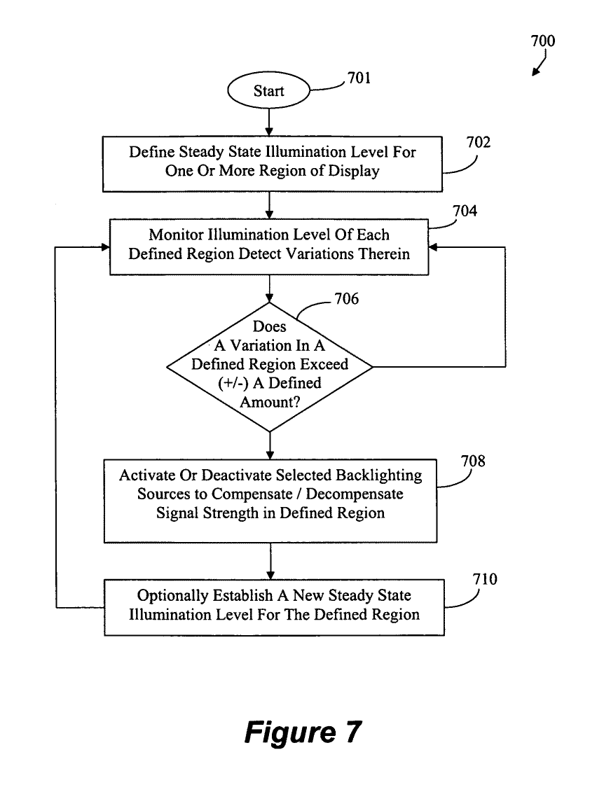

FIG. 7 is a flow chart illustrating an exemplary method for selectively activating backlighting sources 520 in a retroreflector-based optical touch screen system. The method 700 starts at starting block 701 and proceeds to step 702, where a steady state illumination level is defined for one or more region of the display 410, with normal backlighting conditions (i.e., with backlighting sources 520 either activated or deactivated, as intended for normal system operation). A defined region may be, for example, a corner region or other region of interest of the display 410. In some embodiments, the entire viewing area of the display is divided into multiple regions and a steady state illumination level is defined for each one.

The steady state illumination level may be defined during a calibration process, for example. In some cases, it will be desirable to define the steady state illumination level during a known touch event, when the display is otherwise free from environmental contaminants and under typical or expected ambient light conditions, etc. In this way, variations in the illumination level due to a touch, contaminants or ambient conditions are accounted for. Once a steady state illumination level has been determined, the method proceeds to step 704, where the illumination level of each defined region is monitored to detect a variation therein.

When a variation is detected in a defined region, the method proceeds to step 706, for a determination as to whether the variation is of more than a defined amount (e.g., an increase or a decrease in signal strength of more than 30% or some other value determined by the manufacturer, system administrator or user). If not, the method returns to step 704 to continue monitoring the steady state illumination level of the defined region(s). However, if it is determined at step 706 that the variation is of more than the defined amount, the method proceeds to step 708 where an instruction is generated to activate or deactivate one or more backlighting sources 520 to add or reduce backlight illumination in the defined region of the display 410. The amount of backlight illumination provided to or removed from the defined area, may depend on the amount of variation from the steady state illumination level, so as not to over-compensate or under-compensate the signal. The amount of backlight illumination can be controlled by controlling the number of activated or deactivated backlighting sources 520, by altering the duty cycle of the activated backlighting sources 520 and/or by other methods that will be apparent to those of skill in the art.

After activating or deactivating selected backlighting sources 520 in step 708, the method moves to step 710, where a new steady state illumination level for the defined region may optionally be established. This step may be performed automatically by the system, or through a recalibration process performed by the system administrator or user. In some cases, it may not be necessary or desirable to establish a new steady state illumination level for the defined region because the activation/deactivation of backlighting sources 520 is sufficient to maintain the original steady state illumination level for that defined region.

In certain embodiments, the system may generate a notification message to inform the system administrator or user that selected backlighting sources 520 have been activated and that the system should be checked and/or recalibrated. Such a notification message can be displayed on the display 410 aid/or transmitted via a communications link as an email, fax, SMS or other suitable message. For example, if the recursive signal in the defined region has been degraded due to environmental contaminants, the system administrator or user can be prompted to clean the display, thus restoring the recursive signal strength and allowing the selected backlighting sources 520 to be deactivated. Following step 710, the method returns to step 704 to continue monitoring the steady state illumination level of the defined region(s).

The above-described method 700 for selectively enabling/disabling supplemental backlighting for a retroreflective-based optical touch screen system is provided by way of example only. Various and other methods may be performed for achieving the same result, each of which is contemplated by embodiments of the present invention.

FIG. 11A illustrates still a further embodiment of the present invention, in which the design of the position sensing components 430, 431 is configured to improve the performance of the retroreflective-based optical touch screen system 400, particularly in areas of the display 410 that are distant from the optical sensor 421. As shown, each position sensing component 430, 431 includes an electromagnetic radiation source 420 and an optical sensor 421. The optical sensor 421 has a sensor aperture 802. The radiation source 420 is positioned at an angle relative to the sensor aperture 802. In certain embodiments, the radiation source 420 may be placed between 0.1 degrees and 0.3 degrees from the sensor aperture 822. This enhances the flatness of the return signal, reducing the dynamic range required by the optical sensor 421. It reduces the intensity of the reflection compared to angle <0.1 degrees, but the system performance overall can be enhanced.

FIG. 11B shows yet another embodiment, in which the position of the radiation source 421 is not in the plane of the aperture. That is, it is forward or behind the plane or the aperture. Positioning the radiation source such that it is asymmetrical relative to the sensor aperture 802 improves the flatness of return signal from distant parts of the reflector 704. As shown, the observation angles 805a and 805b are different for the light paths, depending on whether they contact the retroreflectoive material 407 on the same side as the radiation source 420. This increased observation angle is employed to reduce the reflectivity when carefully matched to the performance of the specific retro used.

FIG. 9 illustrates an alternative type of prismatic retroreflective film 900, which may be used as the retroreflective material 407 in certain embodiments of the present invention. In this prismatic film 900, the cube corners 902 are metalised with gold or aluminium or other reflective film. This is necessary for oblique entry angles. In this type of prismatic film, the cube corners 902 are canted over at an angle (i.e., the central axis of the cube corner 902 is not normal to the surface of the tape). A prismatic film 900 with canted cube corners 902 has greater reflectivity at extreme entry angles, and lowered reflectivity normal to the film face. Accordingly, areas of the retroreflective film 900 that are most distant from the radiation source produce stronger and more viable recursive signals than retroreflective films that do not have canted cube corners (e.g., retroreflective film 300). The prismatic retroreflective film 900 implements pairs of contra-canted prisms. FIG. 9 shows triangular prisms, but any of the known prism forms can be used where suitable. Where the cant angle is greater than 5 degrees, significant improvement in corner performance is obtained for wide screen formats.

Retro reflective films are known which employ a plurality of prisms canted in a range of directions to give an all round reflectivity. These known films are not suitable for position sensing systems sensors as reflectivity is compromised in directions that no signal is present in the planar touch screen arrangements. In this invention the axis of all cube cants lie within +/−20 degrees of a straight line. This results in a plane of optimal reflectivity.

In some embodiments, a further diversity of cant angles can be used. This can be done by intermixing prisms of differing cant angles, or by using alteniating stripes or blocks of prisms which all have the same cant angle. Where striping is used, the stripes need to be of significantly finer pitch that the minimum pointer size to be resolved. Stripes may be arranged diagonally so that each pixel sees a blend of two different stripes so the average signal level is kept smooth

In other embodiments, portions of prismatic retroreflective films are positioned in an overlapping or zig-zag arrangement to achieve the desired diversity of cant angles along the length of the retroreflective surface of the bezel 405. In yet other embodiments, standard microprism retroreflective sheeting, such as that manufactured by Reflexite, 3M, Stimonsonite and others, may be used to as the retroreflective material 407. In these and other embodiments, the retroreflective sheet may be cut at angle (e.g., 45 degrees or diagonally) across the roll. Different types of sheets may produce advantageous cube corner element designs when cut at other angles. This results in significantly enhanced reflectivity at critical oblique angles of the retroreflective material 407, and increased uniformity in the illumination and signal strength across the entire viewing area of display 410.

Embodiments of the present invention described herein are suitable for touch screen systems of all sizes and dimensions. In certain embodiments of the present invention, particularly in applications with wide screen displays having an oblong aspect ratio (e.g., 16:9 or other non-square areas), it is advantageous to position the optical sensors at or around either end of a short side of the display surface. Given the increased length of the long side of the display surface, it is likely that the points distant from the cameras on the long side will have poor reflectivity. Positioning the sensors on either end of one short side, allows one position sensing device to image each long side. In this case it is only necessary for prisms to be canted toward the single camera. Pairs of prisms canted in opposite directions are not required. This unidirectional canted reflector can be implements in a single film, or as discussed above, the retroreflector may comprise a series of strips of retroreflective material angled toward the respective sensor. Additionally, the cant angles may be variable down the length of the retroreflector to be optimal at each point. In some embodiments, the retroreflective material may comprise a series of segments of having a uniform angle or one compromise angle for the entire length of the retroreflector. The short side reflector may be flat or other of any other arrangement.

Based on the foregoing, it can be seen that the present invention provides performance enhancements for a retroreflector-based optical position sensing system. Many other modifications, features and embodiments of the present invention will become evident to those of skill in the art. For example, those skilled in the art will recognize that embodiments of the present invention are useful and applicable to a variety of applications, including, but not limited to, personal computers, office machinery, gaming equipment, and personal handheld devices. Accordingly, it should be understood that the foregoing relates only to certain embodiments of the invention, and are presented by way of example rather than limitation. Numerous changes may be made to the exemplary embodiments described herein without departing from the spirit and scope of the invention as defined by the following claims.

What is claimed is:

1. An optical position sensing system, comprising:
a display;
a bezel surrounding the display, said bezel having retroreflective material applied thereto;
at least one position sensing component comprising a plurality of radiation sources and an optical sensor, wherein each radiation source emits radiation that contacts reflective components of the retroreflective material at different incident angles to cause illumination of the bezel, and wherein the optical sensor generates data signals representing detected variations in said illumination; and
a processor for processing said data signals to calculate a location of a touch relative to the display.

2. The optical position sensing system of claim 1, wherein the retroreflective material comprises glass bead film.

3. The optical position sensing system of claim 1, wherein the retroreflective material comprises metalized prismatic film.

4. The optical position sensing system of claim 3, wherein the prismatic film comprises a plurality of canted cube corner.

5. The optical position sensing system of claim, wherein the canted corners cubes have a cant angle of greater than 5 degrees.

6. The optical position sensing system of claim 4, wherein the canted prisms corner cubes are facing left and right but all aligned close to a single axis.

7. The optical position sensing system of claim 1, further comprising a plurality of supplemental radiation sources positioned around the bezel so as to provide supplemental backlighting therein.

8. The optical position sensing system of claim 5, wherein each of the plurality of supplemental radiation sources can be individually activated and deactivated, so as to selectively provide said supplemental backlighting to selected areas within the bezel.

9. The optical position sensing system of claim 1, wherein the position sensing component includes an aperture defining a field of view of the optical sensor; and
wherein the each of the plurality of radiation sources is positioned at a different angle relative to the aperture.

10. The optical position sensing system of claim 7, wherein each of the angles is between 0.1 and 0.3 degrees relative to the aperture.

11. An optical position sensing system, comprising:
a display;
a bezel surrounding the display, said bezel having retroreflective material applied thereto;
at least one position sensing component comprising at least one radiation source and an optical sensor, wherein the at least one radiation source emits radiation that contacts reflective components of the retroreflective material to cause illumination of the bezel, and wherein the optical sensor generates data signals representing detected variations in said illumination;
a plurality of supplemental radiation sources positioned around the bezel so as to provide supplemental backlighting therein; and
a processor for processing said data signals to calculate a location of a touch relative to the display.

12. The optical position sensing system of claim 11, wherein the retroreflective material comprises glass bead film.

13. The optical position sensing system of claim 11, wherein the retroreflective material comprises prismatic film.

14. The optical position sensing system of claim 13, wherein the prismatic film comprises a plurality of canted cube corners.

15. The optical position sensing system of claim 14, wherein the canted cube corners have a cant angle of greater than 5 degrees.

16. The optical position sensing system of claim 13, wherein the prismatic comprises an embedded layer of metallized cube corners.

17. The optical position sensing system of claim 11, wherein each of the plurality of supplemental radiation sources can be individually activated and deactivated, so as to selectively provide said supplemental backlighting to selected areas within the bezel.

18. An optical position sensing system, comprising:
a display;
a bezel surrounding the display, said bezel having retroreflective material applied thereto, wherein the retroreflective material is a prismatic film comprising a plurality of canted cube corners;
at least one position sensing component comprising at least one radiation source and an optical sensor, wherein the at least one radiation source emits radiation that contacts reflective components of the retroreflective material to cause illumination of the bezel, and wherein the optical sensor generates data signals representing detected variations in said illumination; and
a processor for processing said data signals to calculate a location of a touch relative to the display.

19. The optical position sensing system of claim 18, wherein the canted cube corners have a cant angle of greater than 5 degrees.

20. The optical position sensing system of claim 18, wherein the canted cube corners have a metallized backing.

21. The optical position sensing system of claim 18, further comprising a plurality of supplemental radiation sources positioned around the bezel so as to provide supplemental backlighting therein.

22. The optical position sensing system of claim 21, wherein each of the plurality of supplemental radiation sources can be individually activated and deactivated, so as to selectively provide said supplemental backlighting to selected areas within the bezel.

23. A method for selectively providing supplemental backlighting to an optical position sensing system, wherein the system comprises a display, a bezel surrounding the display and having retroreflective material applied thereto, and at least one position sensing component comprising a radiation source and an optical sensor, the method comprising:
defining a steady state illumination level detected by said optical sensor for a region of the display;
monitoring an illumination level in the region to detect a variation therein;
in response to detecting the variation, determining whether the variation exceeds a defined amount relative to the steady state illumination level; and
if the variation exceeds the defined amount relative to the steady state illumination level, activating at least one supplemental radiation source positioned around the bezel in proximity to the region.
